(19) United States
(12) Patent Application Publication
(10) Pub. No.: US 2023/0342179 A1
(43) Pub. Date: Oct. 26, 2023

(54) COMPLIANCE ACROSS MULTIPLE CLOUD ENVIRONMENTS

(71) Applicant: AMERIPRISE FINANCIAL, INC., Minneapolis, MN (US)

(72) Inventors: SCOTT SUTTLE, Spring Park, MN (US); KARAN BAVISHI, Lakeville, MN (US); SANDEEP AGARWAL, Jaipur (IN); MANJINDERJEET SINGH, Gurgaon (IN); VIKAS SHARMA, Jaipur (IN); NARESH KUMAR, Woodbury, MN (US)

(73) Assignee: AMERIPRISE FINANCIAL, INC., Minneapolis, MN (US)

(21) Appl. No.: 17/862,758

(22) Filed: Jul. 12, 2022

(30) Foreign Application Priority Data
Apr. 22, 2022 (IN) 202211023843

(51) Int. Cl. G06F 9/455; G06F 9/445

(52) U.S. Cl. CPC G06F 9/45558; G06F 9/44505; G06F 2009/4557; G06F 2009/45587; G06F 2009/45583

(57) ABSTRACT

The method may comprise scanning the configuration of cloud resources and identifying where the cloud resources may have drifted from a desired state. The method may comprise identifying a creation of a cloud resource or a change to a configuration of the cloud resource; scanning, in real-time, the configuration of the cloud resource, in response to the identifying; analyzing the configuration of the cloud resource for deviations from a desired state; determining a type of the cloud resource; determining a deployment of the cloud resource; obtaining a desired state for the configuration of the cloud resource, based on the type of cloud resource and the deployment of the cloud resource; obtaining rule sets for the desired state; identifying the deviations of the configuration of the cloud resource from the desired state and rule sets; and automatically remediating the deviations based on remediation policies.

### CROSS-REFERENCE TO RELATED APPLICATIONS

This application claims priority to and the benefit of India Provisional Application No. 202211023843, entitled “COMPLIANCE ACROSS MULTIPLE CLOUD ENVIRONMENTS,” filed on Apr. 22, 2022, which is hereby incorporated by reference in its entirety for all purposes.

### FIELD

This disclosure generally relates to a cloud automated governance and enforcement tool (AGENT) for monitoring the configuration of cloud resources in a multi-cloud environment, and more particularly, to scanning the configuration of cloud resources and identifying where the cloud resources may have drifted from a desired state.

### BACKGROUND

Public cloud providers (e.g., AWS and Azure) have become more mainstream since around 2006. As companies started using cloud resources, the companies needed to ensure that such cloud resources comply with various company rules and requirements. Therefore, cloud compliance tools were developed that generally operate by periodically (e.g., on a schedule) scanning cloud resources and comparing the compliance data to a desired state (e.g., fixed rule set). If certain compliance data did not conform to the fixed rule set, then it may be determined that the compliance data may include a deviation (or drift) from the rule set. The compliance tool typically records the deviations and delivers a summary of the deviations in a batch report (e.g. nightly report). However, the timeframe from the periodic scanning of the cloud resource, to receiving a batch report at night, to implementing a remediation action, may be a significant timeframe which causes a long delay in rectifying the deviation.

Moreover, the periodic scanning may not be implemented in response to the creation or modification of a cloud resource. Yet, the creation or modification of a cloud resource is the time when deviations are often incorporated into the cloud resource. As such, existing systems may experience a long delay between the creation or modification of a cloud resource and a scanning of the cloud resource for the newly implemented deviations.

To help solve these problems, cloud compliance tools would simply run the compliance scans more frequently and/or such compliance scans would typically scan every cloud resource for a particular company or environment. Such frequent and larger compliance scans would typically utilize significant resources, require more computer power, take much longer to scan and open up various risk exposure windows. As a result, such compliance scans were only run 1-2 times per day. However, if an incorrectly configured resource is deployed into the cloud environment immediately after a scan, such incorrectly configured resource may not be detected until the system runs the next scan which may be 12 or 24 hours later.

Furthermore, in response to running a scan and finding a deviation, existing systems did not have procedures for automatically correcting the deviation. Instead, the existing systems required users to review the reports, develop a remediation strategy and manually remediate any deviations.

### SUMMARY

The disclosure includes, in various embodiments and as set forth in FIG. 1, an exemplary method comprising identifying, by a processor, at least one of a creation of a cloud resource or a change to a configuration of the cloud resource (step 105); scanning, by the processor and in real-time, the configuration of the cloud resource, in response to the identifying (step 110); analyzing, by the processor, the configuration of the cloud resource for deviations from a desired state (step 115); determining, by the processor, a type of the cloud resource (step 120); determining, by the processor, a deployment of the cloud resource (step 125); obtaining, by the processor, a desired state for the configuration of the cloud resource, based on the type of cloud resource and the deployment of the cloud resource (step 130); obtaining, by the processor, rule sets for the desired state (step 135); identifying, by the processor, the deviations of the configuration of the cloud resource from the desired state and rule sets (step 140); and automatically remediating, by the processor, the deviations based on remediation policies (step 145).

The rule sets may be centrally managed and deployed to a plurality of cloud resources. The rule sets may be updated to create updated rule sets and the updated rule sets are deployed to a plurality of cloud resources. The rule sets may be updated within the cloud resource. The deviations may be reported in a comma separated value (CSV) format and/or with the enriched metadata of resources for referencing ITSM (IT Service Management) artifacts of the service. For example, metadata can be used to identify resource owners or exceptions. The method may further comprise determining, by the processor, a state of compliance based on the deviations. The automatically remediating may utilize Python code in conjunction with configuration rules and functions. The automatically remediating may change the configuration to comply with the desired state.

The automatically remediating may further comprise at least one of creating or updating, by the processor, a resource event; marking, by the processor, a resource as NON_COMPLIANT by config rule invocation; triggering, by the processor and using Config rule evaluation event, the Auto remediation workflow (e.g., SSM automation document); invoking, by the processor using the Auto remediation workflow (e.g., SSM automation document), the function (e.g., lambda function); sending, by the processor using the Auto remediation workflow (e.g., SSM automation document), a resource ID as a payload; assuming, by the processor with the function, required roles; obtaining, by the processor with the function, the resource ID from the payload to remediate the resource; and marking, by the processor using a Config rule, the resource as COMPLIANT.

The remediation policies may be preconfigured or determined based on at least one of the scanning, the deviations or the cloud resource. The method may further comprise sending, by the processor, an alert to implement manual intervention for remediating a different set of the deviations based on remediation policies. The method may further comprise preparing, by the processor, a report about at least one of the deviations or the remediating.

The method may further comprise fetching, by the processor, a compliance state from AWS OU root account using AWS Config aggregator; storing, by the processor, data in-memory; enriching, by the processor, the data by querying the cloud resource by assuming IAM role AGENTSCANNER; enhancing, by the processor, the data with predefined values to create output; and sending, by the processor, the output (e.g., including resource compliance state and metadata details) into an S3 bucket in comma separated value (CSV) format which is consumed further in the presentation layer.

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and:

FIG. 1 is an exemplary flow chart of the scanning the configuration of cloud resources and identifying where the cloud resources may have drifted from a desired state, and remediation of the drift, in accordance with various embodiments.

FIG. 2 is an exemplary flow diagram of the AGENT custom code being deployed in multiple areas which adds additional capability beyond the traditional AWS features, in accordance with various embodiments.

### DETAILED DESCRIPTION

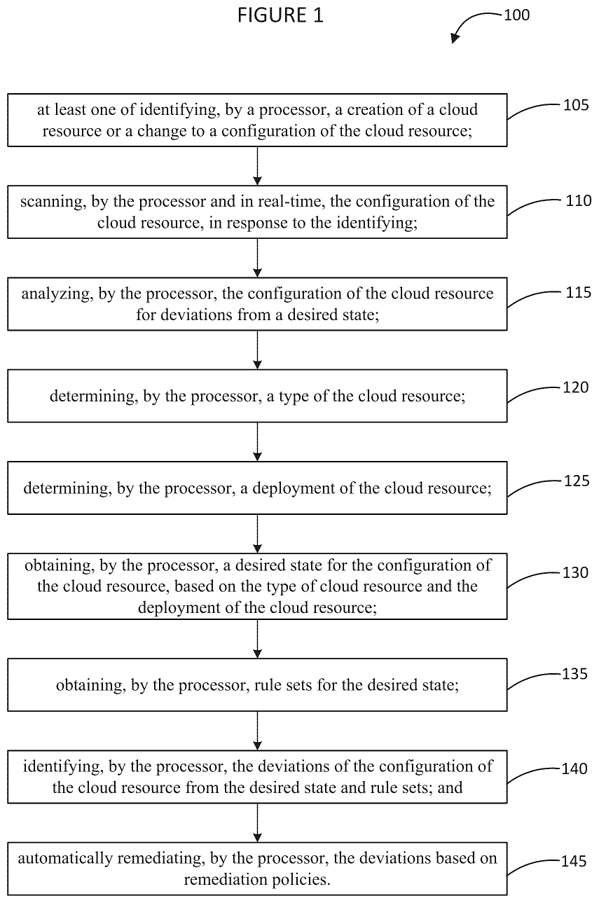

In general, in various embodiments, and as shown in FIG. 1, the disclosure includes a system and method for event-driven scanning of cloud resources that provides real-time governing and compliance (e.g., security compliance). The system may also provide the ability to customize rule sets. Different functions of the system may be embodied as software, hardware, an app, a dashboard and/or a platform. The system may be platform independent, scalable and may plug into various cloud resources. The system may include a flexible design such that the system may be used to govern compliance in different cloud platforms as the cloud platforms expand over time. In that regard, the system may be configured with a pluggable approach such that the system may provide a robust solution capable of handling an increasing number of accounts and cloud offerings for scanning. The system may also plug into different tools to provide even more features and functions, along with an enriched experience. For example, as explained in more detail below, the system may integrate with ServiceNow that develops a cloud computing platform to help companies manage digital workflows for enterprise operations.

The system may give a more real-time view of compliance, and faster remediation of issues, than can be achieved by a tool using scheduled scans. The system may provide improved security and compliance of a cloud environment by, for example, reducing the time a resource may exist in a non-compliant state. The system may also allow for fast access to compliance information for a company's cloud environment via robust dashboarding capability. The system may further lower operating expenses by replacing more expensive commercial tools. The system may also help to reduce the risk of data breaches that may be caused by incorrectly configured cloud resources. The system may be applicable to a variety of large-scale cloud resources such as, for example, Amazon Web Services (AWS) and Azure. For example, CapitalOne experienced a very serious data breach that was mainly due to an overly-permissive Amazon S3 bucket configuration.

In various embodiments, the system may perform one or more of the following method steps. The system may scan the configuration of each cloud resource. The system may analyze the configuration, but the system does not need to analyze the contents of the resource. The desired state may be the same, regardless of how the resource was deployed. In various embodiments, the system may greatly shorten the time a cloud resource may be non-compliant by using this event-driven approach to the scanning. Such event-driven scanning allows an organization to achieve “continuous compliance” of the cloud environment. The system may integrate with the cloud provider to identify a creation of a cloud resource, a change to a configuration of an existing cloud resource or a modification to a configuration of an existing cloud resource. AWS config service may be used to identify these events. In response to a cloud resource being created, changed and/or modified, the system may be notified. In response to the notification, the system may scan the configuration of the cloud resource. The scanning may occur in real-time or near real-time. For example, the scanning may begin immediately, within a few seconds or within a few minutes from the system detecting the creation or modification of a cloud resource. However, the disclosure contemplates that the system may begin scanning in any amount of time.

The system may identify instances where the actual cloud resource configuration has drifted (or deviated) from a desired state. The desired state may be different for each particular cloud resource type and/or the deployment information for the cloud resource. The desired state may be based upon a set of security standards that establish what the true standards should include. The system may identify the drift (or deviation) by acquiring data from the scan of each resource and comparing the data associated with each resource to a collection of rule sets (e.g., rules or policies). The rule set may be centrally managed, and deployed to all cloud resource accounts. As such, in response to the system updating the rule set, the updated rule set may be distributed or updated in each of the cloud resource accounts. Based on the policy definition, the system may determine the state of the compliance. The drift may include any change (e.g., small or large) from the desired state. The system may send a notification about the drift and/or the remediation (e.g., correction). The deviations may be reported in a comma separated value (CSV) format and/or with the enriched metadata of resources for referencing ITSM (IT Service Management) artifacts of the service. For example, metadata can be used to identify resource owners or exceptions. The detection and remediation activity may run in each of the cloud resource accounts. As such, in response to the cloud resource accounts increasing, the use of the underlying cloud services (on which the system operates) may also increase.

In various embodiments, in response to a drift, the system may auto-remediate any portion or all of the drift. To implement the auto-remediation, the system may include Python code in conjunction with configuration rules and functions (e.g., AWS Config and Lambda services). The system may include rules and/or policies. The rules/policies may be pre-configured. The rules/policies may change based on the scan results, the drift and/or the cloud resource. The system may automatically remediate the cloud resource configuration drift (or any portion) by changing the resource configuration to match (or comply with) the desired state where possible. The system may remediate any errors, drift or movement. In various embodiments, the system may remediate minor errors or low risk movement in resources, while larger errors, drifts and movements may result in an alert to implement different types of manual intervention. The system may also log, report and/or send alerts about the configuration drift and/or remediation.

With respect to AWS, the Amazon S3 data storage includes resources known as buckets and objects, wherein a bucket is a container for objects and an object is a file and any metadata that describes that file. To store an object in Amazon S3, a bucket is created and then an object is uploaded to the bucket. An object that is in a bucket can be opened, downloaded and/or moved. When an object or a bucket is no longer need, the resources may be cleaned up. An example of a scan and remediation process may include a desired state for an S3 bucket rule being that the S3 bucket should be created with a server-side encryption parameter being enabled. The system may scan a cloud resource and find that an S3 bucket was created without the server-side encryption parameter enabled such that “user data” is being stored in a virtual compute machine (EC2) in an un-encrypted format. In response to the scan, the system may mark this S3 bucket as non-compliant. The system may also send an alert about the un-encrypted format not complying with the desired state (the desired state being that all user data should be encrypted). The system may implement an auto-remediation, whereby an S3 bucket without server-side encryption being enabled may get remediated based on a rule definition. The remediation may include the S3 bucket being a separate storage location.

The system may deliver its capabilities by combining standard offerings of public clouds such as AWS services (e.g., Config, Lambda, Athena and Quicksight) with custom code and data layers of intelligence. Within the event driven policy framework, and as explained in more details below, the AWS Config may be used to detect the creation or change of a cloud resource. Quicksight may be used to determine if each resource is in the compliance state and present the compliance status. Lambda may run a custom build code (e.g., policies) to evaluate the resource and remediate the configuration, if the configuration is different from the desired state. The system may include additional code or algorithms to customize or extend some of the AWS features. For example, the system may include custom code that evaluates the drift of a resource based on a particular organization's policies. The custom code may also implement the corrective action or alter the resource. The custom code may also aggregate the resource compliance data and use a unique identifier to collect additional resource metadata from the entire infrastructure.

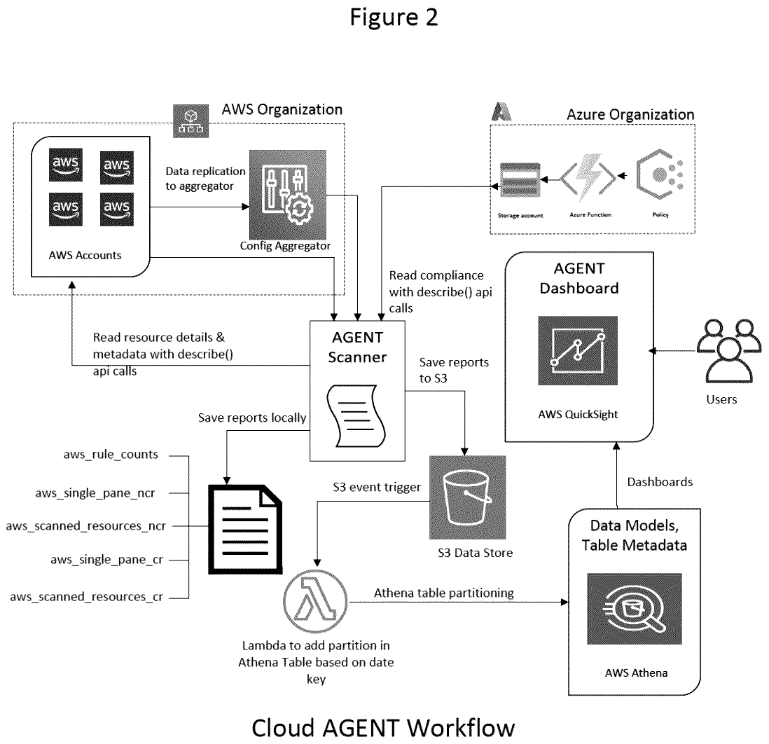

The AGENT custom code may be deployed in multiple areas which adds additional capability beyond the traditional AWS features, wherein an exemplary overall flow may be shown in FIG. 2. “AGENT Custom Config Rules” may provide wider security coverage as per latest security standards and organization wide best security and architectural practices. The list of custom config rules may be referenced below. “AGENT Scanner” may add additional capability in enriching the resource information by collecting resource metadata beyond what is provided by AWS by default as a service offering. For example, the resource state, annotations, tags, resource properties, etc. This data may allow the AGENT to take actions which are not by-default available in AWS services including, for example, triggering an auto remediation workflow, generating ServiceNow ITSM or checking if the non-compliant resource has an associated security exception. “AGENT Presentation Layer” may build multiple intelligence layers of data presentation which can be utilized to determine the compliance status of overall platform or specific cloud resource over time using time series metrics against each rule globally and specific to organizational unit with defined access and governance patterns.

More particularly, with respect to AWS Config, AWS Config is an AWS service that may allow the system to define rules to validate compliance of AWS resources with config specs. AWS provides a number of Managed Config Rules that can be configured without requiring any customization. For rules that are not covered as managed config rules, the system may define those rules as Custom Config Rules. These rules may call AGENT functions which may return the compliance state to AGENT and may trigger pre-configured auto remediation workflow. AGENT rules may be pushed out through CloudFormation. AGENT rules may be deployed to all AWS accounts via CloudFormation StackSets in the root AWS Account. Artifacts may be stored in a version control repository and deployed via a CI/CD pipeline. AGENT artifacts may be versioned and maintained in the AGENT version control repository. The repository may contain multiple branches, such as a branch and a “production” branch. The CI/CD process may update the CloudFormation StackSets.

The following is an exemplary process for deploying New AWS Config Rules into AWS Accounts. Clone the aws-config-global repo locally using git clone. Switch to the c0 branch-git checkout c0, do a git pull to ensure your c0 branch is up to date, and create a new branch with the naming convention feature/{Jira ID/ITSM} ex: git checkout -b “feature/codexample”.

Locate the Nested stack file ConfigUpdates.yml under cloudformation/nested. Make changes to this nested stack to include resources required for your new config rule. If the number of resources in the CFT is nearing 200, a nested stack may be added to keep the deployment within the same nested stack. To create a new custom rule, specify the “PassedMasterConfigRole” to execute the lambda. If additional read-only permissions are required, update the MasterConfigRole resource in the main stack. Avoid creating a new role, if possible. If creating a new auto remediation that will make updates to the resources, create a new role for functions for this purpose. Exemplary format may include “Automation-Config-<rolepurpose>”. Tags may be added so that the ownership is clear. The role can be re-used for SSM documentation invocation. Refer to an existing example and modify the code to particular purposes.

Add/Commit/Push changes to Bitbucket after updates are complete. git add *, git commit -m “Descriptive message”, or git push --set-upstream origin REPLACETHISWITHBRANCHNAME (e.g., git push --set-upstream origin feature/codexample).

Merge changes into c0 may include creating a pull request from your branch to the c0 branch. No approvals are required to merge into c0. Merge the pull request into c0 and validate that the c0 Jenkins build successfully completes. Validate in one of the c0 Sandbox accounts that the expected changes took place.

Merge changes in c3 may include creating a pull request from the c0 branch to the c3 branch. After changes are approved, then approve the PR. Merge a pull request into c3 and validate that the c3 Jenkins build successfully completes. A CHG request may be auto filed, however if Jenkins does not complete successfully it will need to be manually closed. Validate in one of the c3 accounts that the expected changes took place.

For Security Prod account follow the steps below as this account is not uneatable via StackSet. In US-EAST-1, deploy to stack named createCisComplianceRules. Use the same CFT that was used for AMPCreateCentralConfigRules above. Override the STAGINGFOLDER parameter with the same value used in the last run from one of the other accounts. In US-EAST-2 and US-WEST-1, deploy to stack named ConfigRulesSecondaryRegion. Use the same CFT that was used for AMPCreateSecondaryRegionLogging above. Override the STAGINGFOLDER parameter with the same value used in the last run from one of the other accounts.

The lambda code may be tested using the MasterConfig role. In one of the sandbox accounts, calculate the change set using the stackinstances corresponding to the Stacksets above (do notexecute). This helps with validation of the CFT to ensure only intended changes are included If changing the MasterConfigRole, a lot of lambdas and config rules may also show up as conditional changes.

With respect to guardrails for AWS Config Elements, guardrails are in place to protect un-intentional changes by teams outside of Cloud Engineering. The guard rails are in the form of SCPs or resource policies, briefly explained below. There may be two SCPs because of size limitations of the policy, namely, configGuardRailsConfigServiceActions which is used to secure elements within the config service, and configResourcesGuardRails which is used to secure elements used by the config service, such as IAM roles, Lambdas, SSM Documents, KMS Alias that do not support resource policies. Resources such as S3 buckets and KMS keys may be protected through the resources policies directly attached to the S3 buckets/KMS keys.

With respect to monitoring and reporting drift, the system may include 3 trigger methods. AWS Config evaluates resource configurations against the rule when the trigger occurs. Configuration changes: AWS Config runs evaluations for the rule when certain types of resources are created, changed, or deleted. Periodic and configuration changes: AGENT Config runs evaluations for the rule at a chosen frequency (for example, every 24 hours) or based on the configuration changes. Both: If you choose configuration changes and periodic, AGENT Config invokes a function when it detects a configuration change and also at the specified frequency. Information Security reviews the evaluations from AGENT config on periodic basis. Based on the drift, resource(s) drifted and priority, a problem ticket for a priority is assigned to resource owners. Using AGENT Platform, the system may create problem tickets through an automated integration between AGENT and ServiceNow.

The system may also monitor nonstandard region activity via Sumo. AWS Config may be deployed only in regions that are enabled via SCP. For example, the regions are: us-east-1, us-east-2, us-west-1, us-west-2, eu-west-2. This assumes that there must not be any activity in regions other than the above regions in the environment. Even if the monitoring system may not specifically check whether a region is enabled in an account (e.g., us-west-2), the region may not be enabled in many accounts, but it is assumed as allowed across the board. Other processes may be enumerated in Regional activity monitoring that will cover the granular scenarios such as, for example, Monitor Deployment of Mandatory Stacks.

This Sumo query is especially targeted for a Master account that does not have any SCPs and presents difficulties in deploying Config in all regions (like CI/CD buckets, enablement of encryption services in some regions etc.) Even unsuccessful operations may be of interest and could be included. But this may lead to more results that will be analyzed (and possibly discarded). The system may include a list of AFI accounts. Operations such as “Describe*” and “Get*” could be exempted as well (i.e., those that are successful also), but these may include data access methods such as GetObject.

The config rules may include, for example, the following rule descriptions: Checks whether the Amazon DynamoDB tables are encrypted and checks their status. The rule is compliant if the status is enabled or enabling; Checks whether Amazon EFS are configured to encrypt file data using AWS KMS. The rule is NON_COMPLIANT if the Encrypted key is set to False on DescribeFileSystems or if specified KmsKeyId key on DescribeFileSystems is not matching KmsKeyId parameter; Checks whether Amazon Elasticsearch Service (Amazon ES) domains have encryption at rest configuration enabled. The rule is NON_COMPLIANT if EncryptionAtRestOptions field is not enabled; Checks whether Amazon Redshift clusters are not publicly accessible. The rule is NON_COMPLIANT if the publicly Accessible field is true in the cluster configuration item; Checks whether HTTP to HTTPS redirection is configured on all HTTP listeners of Application Load Balancers; Checks that all methods in Amazon API Gateway stages have caching enabled and encrypted; AGENT: Check that detects drift on CloudFormation Stacks tagged with AwsConfigStackDriftDetect=True; Evaluates whether load balancers are created with a scheme of internet-facing; Check IAM Policies for violations; Checks whether IAM User has console access; Checks whether IAM User has multiple active access keys; Check whether RDS is having open security group; Checks whether AWS RDS instances are running on default DB ports; Check whether RDS master username is ‘awsuser’; Check whether PostgreSQL DB Instance rds.force_ssl parameter is set to 1; Checks whether your Amazon CloudFront distributions use HTTPS (directly or via a redirection); Checks whether at least one AWS CloudTrail trail is logging Amazon S3 data events for all S3 buckets. The rule is NON_COMPLIANT if trails log data events for S3 buckets is not configured; Check whether CloudWatch logs are set to expire. Ideally they should be less than the set parameter (default 30 days) but if the expiry is set it is evaluated as compliant; Checks whether a log group in Amazon CloudWatch Logs is encrypted via custom rule; Checks whether the project contains environment variables AWS_ACCESS_KEY_ID and AWS_SECRET_ACCESS_KEY; Checks whether the GitHub or Bitbucket source repository URL contains either personal access tokens or user name and password; AutoGovernance—Check that verifies required tags are properly defined on EBS Volumes; AutoGovernance—Check that verifies required tags are properly defined on managed EC2 Instances; AutoGovernance—Check that verifies required tags are properly defined on managed EKS Clusters; AutoGovernance—Check that verifies required tags are properly defined on ELBv1 and ELBv2; AutoGovernance—Check that verifies required tags are properly defined on IAM Roles; AutoGovernance—Check that verifies required tags are properly defined on IAM Users; AutoGovernance—Check that verifies required tags are properly defined on Lambda Functions; AutoGovernance—Check that verifies required tags are properly defined on RDS Instances; AutoGovernance—Check that verifies required tags are properly defined on S3 Buckets; AutoGovernance—Check that verifies required tags are properly defined on SNS Topics; AutoGovernance—Check that verifies required tags are properly defined on SQS Queues; Check whether Config Recorder is active; Checks whether the Amazon EC2 instances in your account are managed by AWS Systems Manager; Checks whether the compliance status of the AWS Systems Manager patch compliance is COMPLIANT or NON_COMPLIANT after the patch installation on the instance. The rule is compliant if the field status is COMPLIANT; Checks that security groups are attached to Amazon Elastic Compute Cloud (Amazon EC2) instances or to an elastic network interface; Check whether EC2 Instance User Data contains an SSH key; Checks whether Amazon Elasticsearch Service domains are in Amazon Virtual Private Cloud (VPC). The rule is NON_COMPLIANT if Elastic Search Service domain endpoint is public; Checks whether the Classic Load Balancers use SSL certificates provided by AWS Certificate Manager; Checks whether the Application Load Balancers and the Classic Load Balancers have logging enabled; Evaluates all SNS Topics for encryption. Resource is NON_COMPLIANT if there is no ‘KmsMasterKeyId’ in the topic attributes; Evaluates all SQS queues for encryption. Resource is NON_COMPLIANT if there is no encryption configured; Checks whether IAM groups have at least one IAM user; Checks whether your AWS Identity and Access Management (IAM) users have passwords or active access keys that have not been used within the specified number of days provided; Evaluates no RDS instance has my sql version that could contain security vulnerabilities; Check whether ECR Policy is public; Check whether KMS Policy is public; Check whether SNS Policy is public; Check whether SQS Policy is public; Checks whether Amazon Redshift clusters have the specified settings; Checks whether the resources have the tags specified; Check whether Route 53 Public Zone has logging turned on; Check whether S3 Current Version Life Cycle rules are set on an S3 Bucket; Check whether S3 Noncurrent Version Life Cycle rules are set on an S3 Bucket; Check whether security groups are compliant with standards; Evaluates that S3 Bucket referenced by Config exists; Config Rule to detect EC2 Classic Instances; Config Rule to detect RDS Instances using DB Security Groups; Evaluates if AMIs are publicly accessible; Checks whether the required public access block settings are configured from account level. The rule is NON_COMPLIANT when the public access block settings are not configured from account level; Evaluates if any attached cert to an elb is expiring soon; Checks whether the redshift cluster is publicly accessible; Enable Elb Access Logs by giving S3 Bucket Path; Config Rule to detect external IAM principals; Evaluates if s3 bucket allows cross account access. Current Checks:—1.Wildcard access without conditions2.AWS Principal3.Service principal4.Condition—‘ArnEquals’—‘aws:PrincipalArn’; Evaluates that SNS topic referenced by Config exists; Config Rule to detect stale IAM user access keys; Checks whether the Amazon API GW has logging enabled; Evaluates if delivery or notification is failing in cloudtrail; Evaluates if VPC peering connection is pending approval; Evaluates if an IAM user gets new Access Key; Evaluates if a new IAM user is created/updated with admin permissions; Checks that Amazon API Gateway APIs are of the type specified in the rule parameter endpointConfigurationType; Evaluates if lambda execution role has admin privileges; Detects if SNS Subscriptions are using HTTP endpoints; Checks whether the Amazon Relational Database Service (RDS) instances are not publicly accessible; Evaluates that all ALB/NLB are using latest security policy; Detects if SNS Topics are using HTTP; Evaluates that all SNS topics are denying http and sms protocols; Checks whether GuardDuty is enabled. You can optionally verify that the results are centralized in a specific AWS Account; CIS 2.2 2.7—Ensure CloudTrail log file validation is enabled (Scored) ensure CloudTrail logs are encrypted at rest using KMS CMKs (Scored); CIS 2.1 2.4—Ensure CloudTrail is enabled in all regions (Scored) ensure CloudTrail trails are integrated with CloudWatch Logs (Scored) Also check for S3 bucket logging; CIS 1.3—Ensure credentials unused for 90 days or greater are disabled (Scored); Checks whether your Classic Load Balancer SSL listeners are using a custom policy. The rule is only applicable if there are SSL listeners for the Classic Load Balancer; CIS 1.24—Ensure IAM policies that allow full ‘*:*’ administrative privileges are not created (Scored); CIS 4.3—Ensure VPC flow logging is enabled in all VPCs (Scored); CIS 1.21 Ensure IAM instance roles are used for AWS resource access from instances; CIS 2.8—Ensure rotation for customer created CMKs is enabled (Scored); CIS 1.12—Ensure no root account access key exists (Scored) CIS 1.13—Ensure MFA is enabled for the ‘root’ account (Scored) CIS 1.14—Ensure hardware MFA is enabled for the ‘root’ account (Scored); CIS 1.4—Ensure access keys are rotated every 365 days or less (Scored); CIS 4.1—Ensure no security groups allow ingress from 0.0.0.0/0 to port 22 (Scored); Checks that the Amazon S3 bucket either has S3 default encryption enabled or that the S3 bucket policy explicitly denies put-object requests without server side encryption; Checks whether Amazon Elastic Compute Cloud (Amazon EC2) instances have a public IP association. The rule is NON_COMPLIANT if the publicIp field is present in the Amazon EC2 instance configuration item. This rule applies only to IPv4; CIS 1.2—Ensure multi-factor authentication (MFA) is enabled for all IAM users that have a password (Scored); CIS 4.4—Ensure the default security group of every VPC restricts all traffic (Scored); Checks whether AWS CloudTrail is enabled in your AWS account; Checks whether RDS DB instances have backups enabled; Checks whether EBS volumes are attached to EC2 instances; Checks whether all EIP addresses allocated to a VPC are attached to EC2 instances or in-use ENIs; Checks whether your Classic Load Balancer SSL listeners are using a predefined policy. The rule is only applicable if there are SSL listeners for the Classic Load Balancer; Checks whether EBS volumes that are in an attached state are encrypted; Evaluates whether the account password policy for IAM users meets the specified CIS requirements 1.5 through 1.11; Checks whether IAM users are members of at least one IAM group; Checks that none of your IAM users have policies attached. IAM users must inherit permissions from IAM groups or roles; Checks whether the Function (e.g., lambda function) policy prohibits public access; Evaluates whether RDS instance is in a public subnet; Checks whether high availability is enabled for your RDS DB instances; Checks whether storage encryption is enabled for your RDS DB instances; CIS 4.2—Ensure no security groups allow ingress from 0.0.0.0/0 to port 3389 (Scored); Checks whether the root user of your AWS account requires multi-factor authentication for console sign-in; Checks that your S3 buckets do not allow public read access. If an S3 bucket policy or bucket ACL allows public read access the bucket is noncompliant; Checks that your S3 buckets do not allow public write access. If an S3 bucket policy or bucket ACL allows public write access the bucket is noncompliant; Checks whether S3 buckets have policies that require requests to use Secure Socket Layer (SSL); Checks if there are more than 10 k unauthorized access attempts to the CloudTrail logs within the last 48 hours; Checks if there are more than 5 failed console login attempts in last 6 hours; Checks if there is an event in CloudTrail that Stopped, Updated or Deleted the CloudTrail; Checks if there are more than 100 failed login attempts in any account in last 2 hours; Checks if the active access keys are rotated within the number of days specified in maxAccessKeyAge. The rule is NON_COMPLIANT if the access keys have not been rotated for more than maxAccessKeyAge number of days; Checks whether ELBs are using unencrypted protocol; Detects Kinesis Data Streams without Sever Side Encryption enabled with customer managed CMKs; “Checks below configuration setting for Amazon MQ Brokers;—Publicly Accessible MQ Brokers;—MQ Brokers having Encryption using AWS Managed or AWS Owned Keys”; Config rule that checks if an Amazon Relational Database Service (Amazon RDS/Neptune) cluster has deletion protection enabled; Check if the Amazon ElastiCache Redis clusters have automatic backup turned on; Check if the Amazon ElastiCache Redis clusters are well encrypted using customer managed keys and auth token is enabled; Check that Amazon ElasticSearch Service nodes are encrypted end to end; Checks if an Amazon Elastic Container Service (Amazon ECS) task definition with host networking mode has ‘privileged’ or ‘user’ container definitions; Checks configuration setting for Amazon MSK Clusters; Checks if AWS Batch Job definition Fargate version configuration is set to LATEST; Checks if AWS Batch Job definition container image is sourced from AWS ECR; Checks if AWS Batch compute environment type is set to MANAGED; Checks if AWS Batch job definition privileged image configuration setting is set to DISABLED; Checks if AWS Batch job definition container properties does not have public IP configuration set to ENABLED; Checks if AWS Batch job definition container properties does not source secrets from AWS Secret Manager service; Checks configuration setting for Amazon AppFlow connectors; Checks configuration setting for Amazon AppFlow Flows.

The custom AGENT rules may include rule checking for API GW Cache Enabled And Encrypted, Cloud formation Stack Drift Check, Check For Internet-Facing Load Balancers, Check for IAM Policies with excessive permission, Check IAM User With Console Access, Check IAM User With Multiple Active Keys, Check RDS Instance Running On Default Port, Check RDS Master Username, Check RDS SSL DB Parameter, Check CloudWatch Log Expiry Check, CloudWatch Log Group Encrypted, Config Recorder Check, Check if EC2 User Data Secrets, Evaluate SNS Encryption, Evaluate SQS Encryption, MySQL Security Alert, Public ECR Policy Check, Public KMS Policy Check, Public SNS Policy Check, Public SQS Policy Check, Route53 Public Zone Logging Enabled, S3 Lifecycle Check-CurrentVersion, S3LifeCycleCheck-NonCurrentVersion, Security Group Scanner to ensure no wider CIDR or port range specified, S3 Basic Checks for S3 Cross Account Access, API GW Endpoint Type Check, Lambda-Evaluate Lambda Admin Access, SNS-Check HTTP SNS Subscriptions, SNS-Check SNS Topic With HTTP, ELB-Evaluate ELB Security Policy, SNS Check SNS Topic Denying HTTP, Check if Config S3 Bucket exist on all accounts, EC2 Check for EC2 Classic Instance, Check RDS Instance DB Security Group, Evaluate Public Amis, Check for S3 Account Level Public Access Restriction, Check for ELB Cert Expiry, Enable ELB Access Logs, Check Redshift Encryption, Check External IAM Principal, Check Config SNS Topic, Check IAM User Stale Access Keys, Check Cloudtrail Failed Delivery, Check Pending Approval Peering Connection, IAM Check New Created Access Keys, Check New Admin Users Created, Check for RDS With Open Security Group, ELB Using Unencrypted Protocol, Check if Fargate has Public Ip, Check Kinesis Data Streams for service side encryption, Check Amazon MQ Configuration, Elastic cache Redis Cluster Config, Check IAM Roles Admin Privileges, Check for Amazon MSK Configuration, Check for Batch Fargate Version, Check for Batch Image Source, Check for Batch Managed Environment, Check for Batch Privileged Image, Check for Batch service contains Public IP, Check for Batch Secrets, Check for AppFlow service Check Connector Configuration, Check for AppFlow service to ensure Flows Configuration is secure, AWS CloudTrail Sumo Logic Alerts, CIS-CloudTrail Logs Must Be Validated And Encrypted, CIS-CloudTrail Must Be Active, CIS-Disable Unused Credentials, CIS-Evaluate Full Admin Privileges Policies, CIS-Evaluate Vpc Flow Logs, CIS-Format CloudWatch Event, CIS-Get CloudTrail CloudWatch Log, CIS-Instances Must Use IAM Roles, CIS-Root Account Must Have MFA Enabled, CIS-Rotate Access Keys, CIS-Users Must Have MFA Enabled, CIS-Vpc Default Security Groups Must Restrict All Traffic, CIS-Vpc Peering Route Tables Must have Least Access, RDS Instances Must Not Be In Pubic Subnet, Restart Stopped CloudTrail.

The system may help to control certain security items in Azure. The policy mode for each of the security items may include deny, audit or deploy if it does not exist. The applicable checks for the security items that may be controlled include, for example, Virtual Machines Not Protected by a Security Group; Managed Disk Without Delete Lock; Virtual Machines with Unencrypted Disks; Network Security Groups Inbound Rules with Potentially Dangerous Ports Exposed (No Resources); App Service Web Apps SSL Certificates Expiring Soon; App Service with SSL Disabled; Application Gateway with Web Application Firewall (WAF) Disabled; Application Gateways Using an Unsecure Protocol; Application Gateways without Full End-to-End SSL; Blob Containers Set to Full Public Read Access; Blocklisted Public IP Addresses; Containers That Allow Public Blob Access; Load Balancer Rule with a non-SSL Port Enabled; Network Security Groups Inbound Rules Set to All IPs and All Ports; Network Security Groups Inbound Rules Set to All IPs and All Ports (No Resources); Network Security Groups Inbound Rules with Potentially Dangerous Ports Exposed; Network Security Groups Inbound Rules with Specific Ports Exposed; Network Security Groups Inbound Rules with Specific Ports Exposed (No Resources); Network Security Groups Outbound Rules Set to All IPs and All Ports; Network Security Groups Outbound Rules Set to All IPs and All Ports (No Resources); Premium Redis Cache Firewall Allows Broad Range of IPs; Premium Redis Cache Instance with No Firewall Rules; Publicly Accessible SQL Servers; Redis Cache with a non-SSL Port Enabled; Redis Cache without a Resource Lock; Small Application Gateway Usage; SQL Server Database with Transparent Data Encryption Disabled; SQL Server Database without a Resource Lock; SQL Server Firewall Allows Broad Range of IPs; SQL Server Without a Failover Group; SQL Server without a Resource Lock; Storage Account Blob Services without Encryption Enabled; Web Apps With Expired SSL Certificate; Enable Security Contact Configuration in Policy.

The system may provide CIS controls which may be categorized at different levels and have different owners in an organization. The CIS controls may include, for example, Ensure that multi-factor authentication is enabled for all privileged users; Ensure that multi-factor authentication is enabled for all non-privileged users; Ensure that there are no guest users; “Ensure that ‘Allow users to remember multi-factor authentication on; devices they trust’ is ‘Disabled’”; Ensure that ‘Number of methods required to reset’ is set to ‘2’; Ensure that ‘Users can consent to apps accessing company data on their behalf’ is set to ‘No’; Ensure that ‘Users can add gallery apps to their Access Panel’ is set to ‘No’; Ensure that ‘Users can register applications’ is set to ‘No’; Ensure that ‘Guest user permissions are limited’ is set to ‘Yes’; Ensure that ‘Members can invite’ is set to ‘No’; Ensure that ‘Guests can invite’ is set to ‘No’; “Ensure that ‘Restrict access to Azure AD administration portal’ is; set to ‘Yes’”; Ensure that ‘Self-service group management enabled’ is set to ‘No’; Ensure that ‘Users can create security groups’ is set to ‘No’; “Ensure that ‘Users who can manage security groups’ is set to ; ‘None’”; Ensure that ‘Users can create Office 365 groups’ is set to ‘No’; “Ensure that ‘Users who can manage Office 365 groups’ is set to ; ‘None’”; Ensure that ‘Enable “All Users” group’ is set to ‘Yes’; Ensure that ‘Require Multi-Factor Auth to join devices’ is set to ‘Yes’; Ensure that no custom subscription owner roles are created; Ensure that ‘Security contact emails’ is set; Ensure that security contact ‘Phone number’ is set; Ensure that ‘Secure transfer required’ is set to ‘Enabled’; Ensure that storage account access keys are periodically regenerated; Ensure Storage logging is enabled for Queue service for read, write, and delete requests; Ensure that shared access signature tokens expire within an hour; Ensure that shared access signature tokens are allowed only over https; Ensure that ‘Public access level’ is set to Private for blob containers; Ensure default network access rule for Storage Accounts is set to deny; Ensure ‘Trusted Microsoft Services’ is enabled for Storage Account access; Ensure that ‘Auditing’ is set to ‘On’; Ensure that ‘AuditActionGroups’ in ‘auditing’ policy for a SQL server is set properly; Ensure that ‘Auditing’ Retention is ‘greater than 90 days’; Ensure that ‘Advanced Data Security’ on a SQL server is set to ‘On’; Ensure that ‘Threat Detection types’ is set to ‘All’; Ensure that ‘Send alerts to’ is set; Ensure that ‘Email service and co-administrators’ is ‘Enabled’; Ensure that Azure Active Directory Admin is configured; Ensure that ‘Data encryption’ is set to ‘On’ on a SQL Database; Ensure SQL server's TDE protector is encrypted with BYOK (Use your own key); Ensure ‘Enforce SSL connection’ is set to ‘ENABLED’ for MySQL Database Server; Ensure server parameter ‘log_checkpoints’ is set to ‘ON’ for PostgreSQL Database Server; Ensure ‘Enforce SSL connection’ is set to ‘ENABLED’ for PostgreSQL Database Server; Ensure server parameter ‘log_connections’ is set to ‘ON’ for PostgreSQL Database Server; Ensure server parameter ‘log_disconnections’ is set to ‘ON’ for PostgreSQL Database Server; Ensure server parameter ‘log_duration’ is set to ‘ON’ for PostgreSQL Database Server; Ensure server parameter ‘connection_throttling’ is set to ‘ON’ for PostgreSQL Database Server; Ensure server parameter ‘log_retention_days’ is greater than 3 days for PostgreSQL Database Server; Ensure that a Log Profile exists; Ensure the log profile captures activity logs for all regions including global; Ensure the storage container storing the activity logs is not publicly accessible; Ensure the storage account containing the container with activity logs is encrypted with BYOK (Use Your Own Key); Ensure that logging for Azure KeyVault is ‘Enabled’; Ensure that RDP access is restricted from the internet; Ensure that SSH access is restricted from the internet; Ensure no SQL Databases allow ingress 0.0.0.0/0 (ANY IP); Ensure that Network Security Group Flow Log retention period is ‘greater than 90 days’; Ensure that Network Watcher is ‘Enabled’; Ensure that ‘OS disk’ are encrypted; Ensure that ‘Data disks’ are encrypted; Ensure that ‘Unattached disks’ are encrypted; Ensure that only approved extensions are installed; Ensure that the latest OS Patches for all Virtual Machines are applied; Ensure that the endpoint protection for all Virtual Machines is installed; Ensure that the expiration date is set on all keys; Ensure that the expiration date is set on all Secrets; Ensure that Resource Locks are set for mission critical Azure resources; Ensure the key vault is recoverable; Enable role-based access control (RBAC) within Azure Kubernetes Services; Ensure App Service Authentication is set on Azure App Service; Ensure web app redirects all HTTP traffic to HTTPS in Azure App Service; Ensure web app is using the latest version of TLS encryption; Ensure the web app has ‘Client Certificates (Incoming client certificates)’ set to ‘On’; Ensure that Register with Azure Active Directory is enabled on App Service; Ensure that ‘.Net Framework’ version is the latest, if used as a part of the web app; Ensure that ‘PHP version’ is the latest, if used to run the web app; Ensure that ‘Python version’ is the latest, if used to run the web app; Ensure that ‘Java version’ is the latest, if used to run the web app; Ensure that ‘HTTP Version’ is the latest, if used to run the web app.

In various embodiments, the system may integrate with ServiceNow that develops a cloud computing platform to help companies manage digital workflows for enterprise operations. The system may react to compliance change events in AGENT Config and report it to ServiceNow ITSM to create incident/problem/change tickets. In various embodiments, the process may include AWS Config noticing a compliance change reported by any of the deployed config rules. A compliance change in AWS Config may generate a corresponding event which may be watched by an Event Rule. The Event rule may have an event pattern for AWS Config Compliance Change Notification. The Event rule may trigger a lambda as a target and pass the event to lambda for processing. Lambda may parse the event and fetch all the required information from the event. As an end result, lambda may log the information to its specific CloudWatch Log group. The system may include the ‘Non_Compliant’ event information as a JSON object in logger INFO or any other specific keyword. This would be helpful to filter out and only send Non_Compliant data to SumoLogic to avoid hitting data limits in sumo and avoid writing complex queries in SumoLogic. Event Parser Lambda's log group may have an associated ‘LogGroupSubscriptionFilter’ that subscribes to ‘CloudWatchToSumoLogic’ log shipper lambda. The system may filter out only Non_Compliant data to be sent to log shipper for the benefits explained above. Log Shipper Lambda may process the passed logs and ship them to SumoLogic. The system may create a respective query in SumoLogic and schedule it to start creating events in Snow and eventually incidents. The system may include this process as a default setup for creating incidents from sumo. For any specific requirement such as, for example, creating problem tickets instead of incidents or changing ‘Type’ from ‘Generic’ to ‘AGENT’, the system may create Tasks in a Monitoring team's queue with proper justification. For example, the system may query if only Non_Complaint data is shipped to SumoLogic.

In various embodiments, the system may include the following auto remediation workflow. AWS Config provides the capability to remediate noncompliant resources that are evaluated by AWS Config Rules. AWS Config may apply remediation using AWS Systems Manager Automation documents. The system may define the actions to be performed on noncompliant AWS resources evaluated by AWS Config Rules. The system may use AWS Config, AWS Lambda and AWS Systems Manager Automation documents for auto remediation. The auto remediation process may include, for example, Create/Update Resource Event, Config Rule invocation, Resource marked as NON_COMPLIANT by config rule invocation, Auto remediation workflow invoked by Config rule evaluation event and triggers the Auto remediation workflow (e.g., SSM automation document), the Auto remediation workflow (e.g., SSM automation document) invokes the function (e.g., lambda function) and sends resource ID as a payload, the Function (e.g., lambda function) assumes the required roles and gets the resource ID from payload to remediate the resource (as per defined logic), and the Config rule marks the resource as COMPLIANT. An exemplary config rule may check that the Amazon S3 bucket either has S3 default encryption enabled or that the S3 bucket policy explicitly denies put-object requests without server side encryption. Another exemplary config rule may check whether the required public access block settings are configured from account level. The rule is NON_COMPLIANT when the public access block settings are not configured from account level.

The system includes an event driven policy framework such that any event created at the resource level may be picked by the associated AGENT config rule and AGENT functions to enforce the desired state. Based on the evaluation done by the associated checks, the final result of the resource status may be stored in the AGENT Config data (Compliant/Non-Compliant). The system may refresh the data at any frequency. For example, the data may be refreshed every 24 hours on the QuickSight dashboards.

The system may include a scanner. The scanner may periodically run to capture the resource state, enriches data (severity, documentation, etc.) and prepares an exception list. The scanner may be a python-based utility hosted in a dedicated system account responsible to perform certain functions. For example, the system may include the functions of fetching the overall platform compliance state and related metadata from AWS Organization. The system may then include storing the data in-memory and enriching the data by querying each of the AWS account by assuming IAM role AGENTSCANNER. In response to the data being captured and enriched, the next job of the Scanner is to further enhance the data with predefined values like (Priority, Service Type etc.). The Scanner may then send the output into the S3 bucket in CSV format which can be consumed further in the presentation layer. The scanner may then generate certain reports. The reports may provide a rule specific count of COMPLIANT and NON_COMPLIANT resources in every AWS account. The reports may provide a list of NON_COMPLIANT resources reported by all of the config rules in every AWS account. The reports may provide lists of all NON_COMPLIANT resources along with resource KEY, ARN, Tags etc. The reports may provide a list of COMPLIANT resources reported by all of the config rules in every AWS account. The reports may include lists of all COMPLIANT resources along with resource KEY, ARN, Tags etc.

The system may include a branching strategy. The source code for the reporting solution may be available in a AGENT-source code repository. The branches that may be used for managing the source code include a master branch to deploy code on PROD and DR servers. A develop branch may deploy code on Dev servers. The system may use another AWS cloud native service called “AWS Quicksight” as a presentation layer. The system may create dashboards using Athena datasets.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not for purposes of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy,” “meet,” “match,” “associated with”, or similar phrases may include an identical match, a partial match, meeting certain criteria, matching a subset of data, a correlation, satisfying certain criteria, a correspondence, an association, an algorithmic relationship, and/or the like. Similarly, as used herein, “authenticate” or similar terms may include an exact authentication, a partial authentication, authenticating a subset of data, a correspondence, satisfying certain criteria, an association, an algorithmic relationship, and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodically, randomly, once, more than once, or in response to a suitable request or action. Any of the information may be distributed and/or accessed via a software enabled link, wherein the link may be sent via an email, text, post, social network input, and/or any other method known in the art.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY DISC®, optical storage devices, magnetic storage devices, and/or the like.

In various embodiments, components, modules, and/or engines of the system may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEBSPRERE® MQ™ (formerly MQSeries) by IBM®, Inc. (Armonk, NY) is an example of a commercially available middleware product. An Enterprise Service Bus (“ESB”) application is another example of middleware.

The computers discussed herein may provide a suitable website or other internet-based graphical user interface which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHEx web server is used in conjunction with a LINUX® operating system, a MYSQL® database, and PERL®, PHP, Ruby, and/or PYTHON® programming languages.

For the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

In various embodiments, the system and various components may integrate with one or more smart digital assistant technologies. For example, exemplary smart digital assistant technologies may include the ALEXA® system developed by the AMAZON® company, the GOOGLE HOME® system developed by Alphabet, Inc., the HOMEPOD® system of the APPLE® company, and/or similar digital assistant technologies. The ALEXA® system, GOOGLE HOME® system, and HOMEPOD® system, may each provide cloud-based voice activation services that can assist with tasks, entertainment, general information, and more. All the ALEXA® devices, such as the AMAZON ECHO®, AMAZON ECHO DOT®, AMAZON TAP®, and AMAZON FIRE® TV, have access to the ALEXA® system. The ALEXA® system, GOOGLE HOME® system, and HOMEPOD® system may receive voice commands via its voice activation technology, activate other functions, control smart devices, and/or gather information. For example, the smart digital assistant technologies may be used to interact with music, emails, texts, phone calls, question answering, home improvement information, smart home communication/activation, games, shopping, making to-do lists, setting alarms, streaming podcasts, playing audiobooks, and providing weather, traffic, and other real time information, such as news. The ALEXA®, GOOGLE HOME®, and HOMEPOD® systems may also allow the user to access information about eligible transaction accounts linked to an online account across all digital assistant-enabled devices.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include client data; merchant data; financial institution data; and/or like data useful in the operation of the system. As those skilled in the art will appreciate, user computer may include an operating system (e.g., WINDOWS®, UNIX®, LINUX®, SOLARIS®, MACOS , etc.) as well as various conventional support software and drivers typically associated with computers.

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

In various embodiments, the embodiments are directed toward one or more computer systems capable of carrying out the functionalities described herein. The computer system includes one or more processors. The processor is connected to a communication infrastructure (e.g., a communications bus, cross-over bar, network, etc.). Various software embodiments are described in terms of this exemplary computer system. After reading this description, it will become apparent to a person skilled in the relevant art(s) how to implement various embodiments using other computer systems and/or architectures. The computer system can include a display interface that forwards graphics, text, and other data from the communication infrastructure (or from a frame buffer not shown) for display on a display unit.

The computer system also includes a main memory, such as random access memory (RAM), and may also include a secondary memory. The secondary memory may include, for example, a hard disk drive, a solid-state drive, and/or a removable storage drive. The removable storage drive reads from and/or writes to a removable storage unit in a well-known manner. As will be appreciated, the removable storage unit includes a computer usable storage medium having stored therein computer software and/or data.

In various embodiments, secondary memory may include other similar devices for allowing computer programs or other instructions to be loaded into a computer system. Such devices may include, for example, a removable storage unit and an interface. Examples of such may include a program cartridge and cartridge interface (such as that found in video game devices), a removable memory chip (such as an erasable programmable read only memory (EPROM), programmable read only memory (PROM)) and associated socket, or other removable storage units and interfaces, which allow software and data to be transferred from the removable storage unit to a computer system.

The terms “computer program medium,” “computer usable medium,” and “computer readable medium” are used to generally refer to media such as removable storage drive and a hard disk installed in hard disk drive. These computer program products provide software to a computer system.

The computer system may also include a communications interface. A communications interface allows software and data to be transferred between the computer system and external devices. Examples of such a communications interface may include a modem, a network interface (such as an Ethernet card), a communications port, etc. Software and data transferred via the communications interface are in the form of signals which may be electronic, electromagnetic, optical, or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16-bit integers.

In various embodiments, the server may include application servers (e.g., WEB SPHERE®, WEBLOGIC®, JBOSS®, POSTGRES PLUS ADVANCED SERVER®, etc.). In various embodiments, the server may include web servers (e.g., Apache, IIS, GOOGLE® Web Server, SUN JAVA® System Web Server, JAVA® Virtual Machine running on LINUX® or WINDOWS® operating systems).

A web client includes any device or software which communicates via any network, such as, for example any device or software discussed herein. The web client may include internet browsing software installed within a computing unit or system to conduct online transactions and/or communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system (e.g., WINDOWS®, WINDOWS MOBILE® operating systems, UNIX® operating system, LINUX® operating systems, APPLE® OS® operating systems, etc.) as well as various conventional support software and drivers typically associated with computers. The web-client may also run MICROSOFT® INTERNET EXPLORER® software, MOZILLA® FIREFOX® software, GOOGLE CHROMETM software, APPLE® SAFARI® software, or any other of the myriad software packages available for browsing the internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an internet server. For example, the web client may communicate with the server via a load balancer. In various embodiments, web client access is through a network or the internet through a commercially-available web-browser software package. In that regard, the web client may be in a home or business environment with access to the network or the internet. The web client may implement security protocols such as Secure Sockets Layer (SSL) and Transport Layer Security (TLS). A web client may implement several application layer protocols including HTTP, HTTPS, FTP, and SFTP.

The various system components may be independently, separately, or collectively suitably coupled to the network via data links which includes, for example, a connection to an Internet Service Provider (ISP) over the local loop as is typically used in connection with standard modem communication, cable modem, DISH NETWORK®, ISDN, Digital Subscriber Line (DSL), or various wireless communication methods. It is noted that the network may be implemented as other types of networks, such as an interactive television (ITV) network. Moreover, the system contemplates the use, sale, or distribution of any goods, services, or information over any network having similar functionality described herein.

The system contemplates uses in association with web services, utility computing, pervasive and individualized computing, security and identity solutions, autonomic computing, cloud computing, commodity computing, mobility and wireless solutions, open source, biometrics, grid computing, and/or mesh computing.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT And XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. For example, representational state transfer (REST), or RESTful, web services may provide one way of enabling interoperability between applications.

The computing unit of the web client may be further equipped with an internet browser connected to the internet or an intranet using standard dial-up, cable, DSL, or any other internet protocol known in the art. Transactions originating at a web client may pass through a firewall in order to prevent unauthorized access from users of other networks. Further, additional firewalls may be deployed between the varying components of CMS to further enhance security.

Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, Triple DES, Blowfish, AES, MD5, HMAC, IDEA, RC6, and symmetric and asymmetric cryptosystems. The systems and methods may also incorporate SHA series cryptographic methods, elliptic curve cryptography (e.g., ECC, ECDH, ECDSA, etc.), and/or other post-quantum cryptography algorithms under development.

The firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the internet. A firewall may be integrated as software within an internet server or any other application server components, reside within another computing device, or take the form of a standalone hardware component.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, NY), various database products available from ORACLE® Corporation (Redwood Shores, CA), MICROSOFT ACCESS® or MICROSOFT SQL SERVER® by MICROSOFT® Corporation (Redmond, Washington), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user, or the like. Furthermore, the security information may restrict/permit only certain actions, such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the transaction device along with the associated issuer-owned data, but instead the appropriate action may be taken by providing to the user, at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The data may be big data that is processed by a distributed computing cluster. The distributed computing cluster may be, for example, a HADOOP® software cluster configured to process and store big data sets with some of nodes comprising a distributed storage system and some of nodes comprising a distributed processing system. In that regard, distributed computing cluster may be configured to support a HADOOP® software distributed file system (HDFS) as specified by the Apache Software Foundation at www.hadoop.apache.org/docs.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, interne, point of interaction device (point of sale device, personal digital assistant (e.g., an IPHONE® device, a BLACKBERRY® device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

As used herein, “transmit” may include sending electronic data from one system component to another over a network connection. Additionally, as used herein, “data” may include encompassing information such as commands, queries, files, data for storage, and the like in digital or any other form.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a HYPERLEDGER® Fabric 1.0 based platform, the duration is driven by the specific consensus algorithm that is chosen, and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network.

The particular blockchain implementation described herein provides improvements over conventional technology by using a decentralized database and improved processing environments. In particular, the blockchain implementation improves computer performance by, for example, leveraging decentralized resources (e.g., lower latency). The distributed computational resources improves computer performance by, for example, reducing processing times. Furthermore, the distributed computational resources improves computer performance by improving security using, for example, cryptographic protocols.

Any communication, transmission, and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV®, MICROSOFT® XBOX®, ROKU®, AMAZON FIRE®, GOOGLE CHROMECAST™, SONY® PLAYSTATION®, NINTENDO® SWITCH®, etc.) a uniform resource locator (“URL”), a document (e.g., a MICROSOFT® Word or EXCEL™, an ADOBE® Portable Document Format (PDF) document, etc.), an “ebook,” an “emagazine,” an application or microapplication (as described herein), an short message service (SMS) or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUIMBLR®, REDDIT®, SNAPCHAT®, WHATSAPP®, FLICKR®, VK®, QZONE®, WECHAT®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

1. A method comprising:
identifying, by a processor, at least one of a creation of a cloud resource or a change to a configuration of the cloud resource;
scanning, by the processor and in real-time, the configuration of the cloud resource, in response to the identifying;
analyzing, by the processor, the configuration of the cloud resource for deviations from a desired state;
determining, by the processor, a type of the cloud resource;
determining, by the processor, a deployment of the cloud resource;
obtaining, by the processor, a desired state for the configuration of the cloud resource, based on the type of cloud resource and the deployment of the cloud resource;
obtaining, by the processor, rule sets for the desired state;
identifying, by the processor, the deviations of the configuration of the cloud resource from the desired state and rule sets; and
automatically remediating, by the processor, the deviations based on remediation policies.

2. The method of claim 1, wherein the rule sets are centrally managed and deployed to a plurality of cloud resources.

3. The method of claim 1, wherein the rule sets are updated to create updated rule sets and the updated rule sets are deployed to a plurality of cloud resources.

4. The method of claim 1, wherein the rule sets are updated within the cloud resource.

5. The method of claim 1, wherein the deviations are reported in at least one of a comma separated value (CSV) format or with enriched metadata of resources for referencing ITSM (IT Service Management) artifacts.

6. The method of claim 1, further comprising determining, by the processor, a state of compliance based on the deviations.

7. The method of claim 1, wherein the automatically remediating utilizes Python code in conjunction with configuration rules and functions.

8. The method of claim 1, wherein the automatically remediating changes the configuration to comply with the desired state.

9. The method of claim 1, wherein the automatically remediating further comprises:
at least one of creating or updating, by the processor, a resource event;
marking, by the processor, a resource as NON_COMPLIANT by config rule invocation;
triggering, by the processor and using Config rule evaluation event, the Auto remediation workflow;
invoking, by the processor using the Auto remediation workflow, the function;
sending, by the processor using the Auto remediation workflow, a resource ID as a payload;
assuming, by the processor with the function, required roles;
obtaining, by the processor with the function, the resource ID from the payload to remediate the resource; and
marking, by the processor using a Config rule, the resource as COMPLIANT.

10. The method of claim 1, wherein the remediation policies are preconfigured.

11. The method of claim 1, wherein the remediation policies are determined based on at least one of the scanning, the deviations or the cloud resource.

12. The method of claim 1, further comprising sending, by the processor, an alert to implement manual intervention for remediating a different set of the deviations based on remediation policies.

13. The method of claim 1, further comprising preparing, by the processor, a report about at least one of the deviations or the remediating.

14. The method of claim 1, further comprising:
fetching, by the processor, a compliance state from AWS OU root account using AWS Config aggregator;
storing, by the processor, data in-memory;
enriching, by the processor, the data by querying the cloud resource by assuming 1AM role AGENTSCANNER;
enhancing, by the processor, the data with predefined values to create output; and
sending, by the processor, the output into an S3 bucket in comma separated value (CSV) format which is consumed further in the presentation layer.

15. A system comprising:
a processor; and
a tangible, non-transitory memory configured to communicate with the processor,
the tangible, non-transitory memory having instructions stored thereon that, in response to execution by the processor, cause the processor to perform operations comprising:
identifying, by the processor, at least one of a creation of a cloud resource or a change to a configuration of the cloud resource;
scanning, by the processor and in real-time, the configuration of the cloud resource, in response to the identifying;
analyzing, by the processor, the configuration of the cloud resource for deviations from a desired state;
determining, by the processor, a type of the cloud resource;
determining, by the processor, a deployment of the cloud resource;
obtaining, by the processor, a desired state for the configuration of the cloud resource, based on the type of cloud resource and the deployment of the cloud resource;
obtaining, by the processor, rule sets for the desired state;
identifying, by the processor, the deviations of the configuration of the cloud resource from the desired state and rule sets; and
automatically remediating, by the processor, the deviations based on remediation policies.
